(19) United States
(12) Patent Application Publication
(10) Pub. No.: US 2015/0185484 A1
(43) Pub. Date: Jul. 2, 2015

(54) PUPIL TRACKING APPARATUS AND METHOD

(71) Applicant: Electronics and Telecommunications Research Institute, Daejeon (KR)

(72) Inventors: Hyon Gon CHOO, Daejeon (KR); Soo Hyun LEE, Daejeon (KR); Jin Woong KIM, Daejeon (KR); Hyun Eui KIM, Cheongju (KR); Kyung Ae MOON, Daejeon (KR); Min Sik PARK, Sejong (KR)

(73) Assignee: Electronics and Telecommunications Research Institute, Daejeon (KR)

(21) Appl. No.: 14/584,870

(22) Filed: Dec. 29, 2014

(30) Foreign Application Priority Data
Dec. 30, 2013 (KR) 10-2013-0167598
Oct. 17, 2014 (KR) 10-2014-0140919

(51) Int. Cl. G02B 27/01; G02B 27/00

(52) U.S. Cl. CPC G02B 27/0179; G02B 27/0103; G02B 27/0093; G02B 2027/0138; G02B 2027/014; G02B 2027/0187

(57) ABSTRACT

Provided is a pupil tracking apparatus and method, the apparatus including an image acquirer to acquire an image of an object by capturing the object, a space position detector to detect, from the image, a three-dimensional (3D) position of a predetermined portion in the object, and a display to output a hologram to a space corresponding to the 3D position.

### CROSS-REFERENCE TO RELATED APPLICATION

This application claims the priority benefit of Korean Patent Application No. 10-2013-0167598 filed on Dec. 30, 2013 and Korean Patent Application No. 10-2014-0140919 filed on Oct. 17, 2014 in the Korean Intellectual Property Office, the disclosures of which are incorporated herein by reference.

### BACKGROUND

1. Field of the Invention

Embodiments of the present invention relate to technology for tracking a position of a pupil corresponding to a space in which a hologram is output, using an image acquired with respect to an object at a different angle, thereby extending a field of vision for a digital hologram display of which the field of vision is restricted in general.

2. Description of the Related Art

In digital holography display technology, a three-dimensional (3D) image may be output to a 3D space based on a light, for example, laser diffraction effect using a spatial light modulator (SLM). A table-tower holographic display may indicate a display realized by outputting an image to a space above a planar table based on holography display technology such that a 3D image may be viewed over a full range of 360°.

FIG. 1 illustrates a principle of displaying a floating image in a space by reflecting a laser to a spherical mirror according to a related art, and FIG. 2 illustrates a principle of displaying a floating image in a space based on light reflected from an eye of a viewer according to a related art.

Referring to FIGS. 1 and 2, a holographic display may realize an effect of an image floating in a space by adjusting a direction of a laser diffraction angle based on an optical effect using a spherical mirror. For example, the holographic display may realize the effect by projecting an image diffracted in a viewing direction of a user, onto an air in various directions.

Similarly to the holographic display, the table-tower holographic display may use the SLM and the laser and thus, a hologram observance range may be limited due to a pixel size of the SLM.

Accordingly, there is a desire for a method of adjusting a direction of light output through the SLM and the laser based on a position of a pupil of a viewer, and technology for accurately tracking the pupil of the viewer in a space may be used to implement the above method.

### SUMMARY

An aspect of the present invention provides technology for tracking a position of a pupil corresponding to a space to which a hologram is output, using an image acquired with respect to an object at a different angle, thereby extending a field of vision for a digital hologram display of which the field of vision is generally restricted.

According to an aspect of the present invention, there is provided a pupil tracking apparatus including, an image acquirer to capture an image of an object, a space position detector to detect, from the image, a three-dimensional (3D) position of a predetermined portion in the object, and a display to output a hologram to a space corresponding to the 3D position.

The image acquirer may include n cameras disposed at different bearings, n being a natural number.

Each of the n cameras may correspond to one of a stereo camera, a color camera, and a depth camera.

The space position detector may include a pupil tracker to determine whether the image includes a pupil as the predetermined portion, and track a two-dimensional (2D) position of the pupil in response to a determination that the image includes the pupil.

The pupil tracker may divide the image into a plurality of predetermined areas, track, as an eye area of a face, an area having a greatest value output through a pupil classifier among the divided areas, and track the pupil in the eye area.

The space position detector may further include a pupil position calculator to calculate a 3D position of the pupil based on the 2D position of the pupil and status information associated with a camera in the image acquirer.

The image acquirer may include an omnidirectional camera to omnidirectionally capture the object, and a plurality of panorama cameras to capture the object at different bearings so as to acquire an omnidirectional panoramic image.

The pupil tracking apparatus may further include an image selector to select at least one panorama camera from among the plurality of panorama cameras based on camera identification information received from the omnidirectional camera, receive an image from the selected panorama camera, and transfer the receive image to the space position detector.

When the object is extracted from the image, the omnidirectional camera may provide, to the image selector, the camera identification information corresponding to a bearing at which the object is positioned.

According to another aspect of the present invention, there is also provided a pupil tracking method including acquiring an image of an object by capturing the object, detecting, from the image, a 3D position of a predetermined portion in the object, and outputting a hologram to a space corresponding to the 3D position.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a principle of displaying a floating image in a space by reflecting laser to a spherical mirror according to a related art;

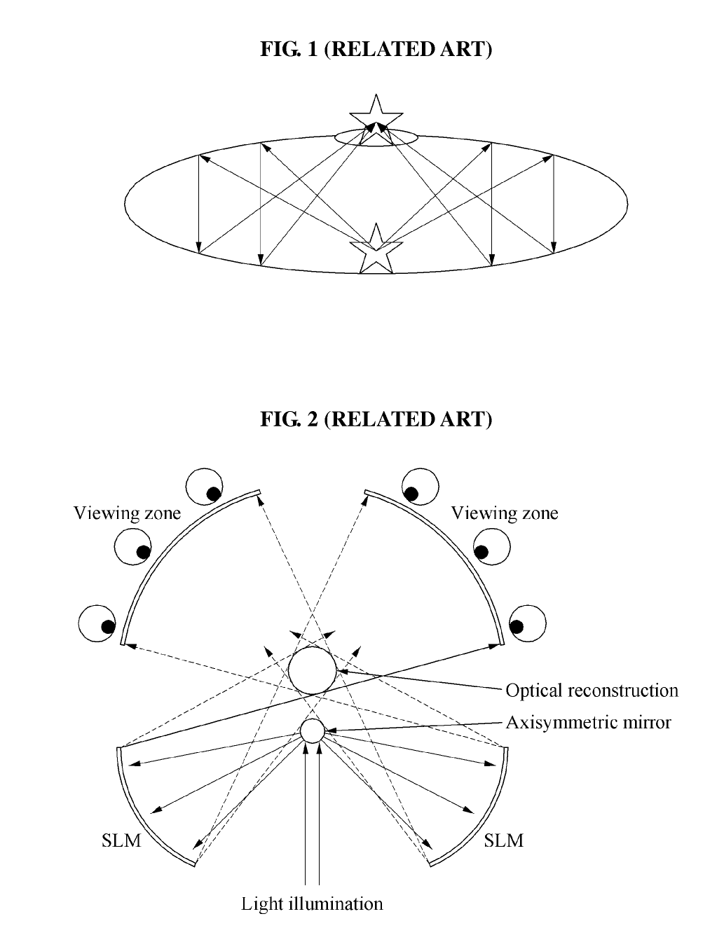

FIG. 2 illustrates a principle of displaying a floating image in a space based on light reflected from an eye of a viewer according to a related art;

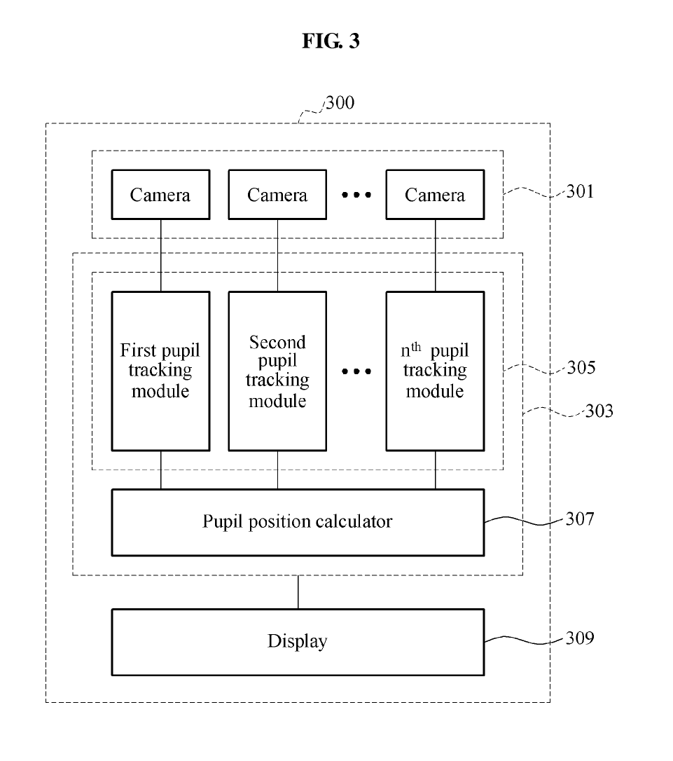

FIG. 3 illustrates a configuration of a pupil tracking apparatus according to an example embodiment of the present invention;

FIG. 4 illustrates a camera arrangement in a pupil tracking apparatus according to an example embodiment of the present invention;

FIGS. 5A and 5B illustrate an example of tracking a position of a pupil using a pupil tracking apparatus according to an example embodiment of the present invention;

FIG. 6 illustrates a configuration of a pupil tracking apparatus according to another example embodiment of the present invention;

FIGS. 7 and 8 illustrate a camera arrangement in a pupil tracking apparatus according to another example embodiment of the present invention; and

FIG. 9 illustrates a pupil tracking method according to an example embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

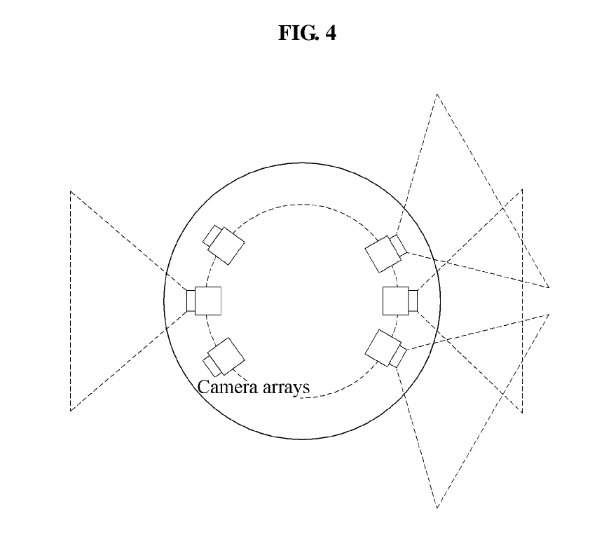

FIG. 3 illustrates a configuration of a pupil tracking apparatus 300 according to an example embodiment of the present invention.

Referring to FIG. 3, the pupil tracking apparatus 300 includes an image acquirer 301, a space position detector 303, and a display 309.

The image acquirer 301 may include n cameras disposed at different bearings, n being a natural number. The n cameras may be used to capture an object, for example, a person, and acquire an image of the object. In this example, the image acquirer 301 may include two stereo cameras, each disposed at a corresponding bearing, or a camera, for example, a depth camera, to recognize the object based on three-dimensional (3D) information, for example, depth information and color information.

The n cameras in the image acquirer 301 may be connected to n pupil tracking modules in a pupil tracker 305, respectively. Through this, the n cameras may transfer images of the object to the n pupil tracking modules.

The space position detector 303 may detect a 3D position of a predetermined portion, for example, the pupil, in the object, from the image received from the image acquirer 301. In this example, the space position detector 303 may include the pupil tracker 305 and a pupil position calculator 307.

The pupil tracker 305 may include the n pupil tracking modules, for example, a first pupil tracking module through an n^{th} pupil tracking module. The pupil tracking module may receive an image from a camera, and determine whether the received image includes the pupil. The pupil tracking module may divide the image into a plurality of predetermined areas, track an eye area of a face in an area determined as including the face, and track the pupil in the eye area. In this example, the pupil tracking module may track, as the eye area of the face, an area having a greatest value output through a pupil classifier among the divided areas.

For example, in response to a determination that the image includes the pupil, the pupil tracking module may extract the face from the image and detect a position of an eye from the extracted face, thereby tracking a two-dimensional (2D) position of the pupil, for example, a left pupil and a right pupil, included in the position of the eye.

Each of the n pupil tracking modules may transfer the tracked 2D position of the pupil, to the pupil space calculator 307.

The pupil position calculator 307 may receive the 2D position of the pupil from each of the n pupil tracking modules in the pupil tracker 305, and calculate the 3D position of the pupil based on the received 2D position and status information, for example, information on a position, an angle, a direction of a camera, and a resolution provided from the camera, associated with the n cameras.

In this example, the pupil space calculator 307 may receive 2D positions of the left and right pupils from each of the n pupil tracking modules in the pupil tracker 305, and calculate 3D positions of the left and right pupils based on the received 2D positions of the left and right pupils. When the image is acquired using the two stereo cameras, the pupil position calculator 307 may calculate the 3D positions of the left and right pupil, and a distance between the left and right pupils based on a disparity between the two stereo cameras positioned consecutively.

The display 309 may output a generated hologram to a space corresponding to the 3D position of the predetermined portion detected by the space position detector 303, for example, the 3D position of the pupil.

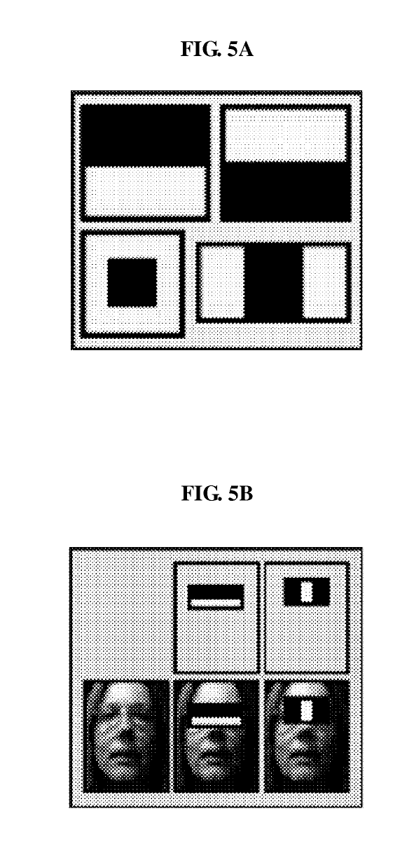

FIG. 4 illustrates a camera arrangement in a pupil tracking apparatus according to an example embodiment of the present invention.

Referring to FIG. 4, the pupil tracking apparatus may capture an object, for example, a person to acquire a plurality of images using a plurality of cameras, for example, camera arrays, disposed at different bearings. In this example, the plurality of cameras may be disposed to be spaced apart from one another along a virtual circle.

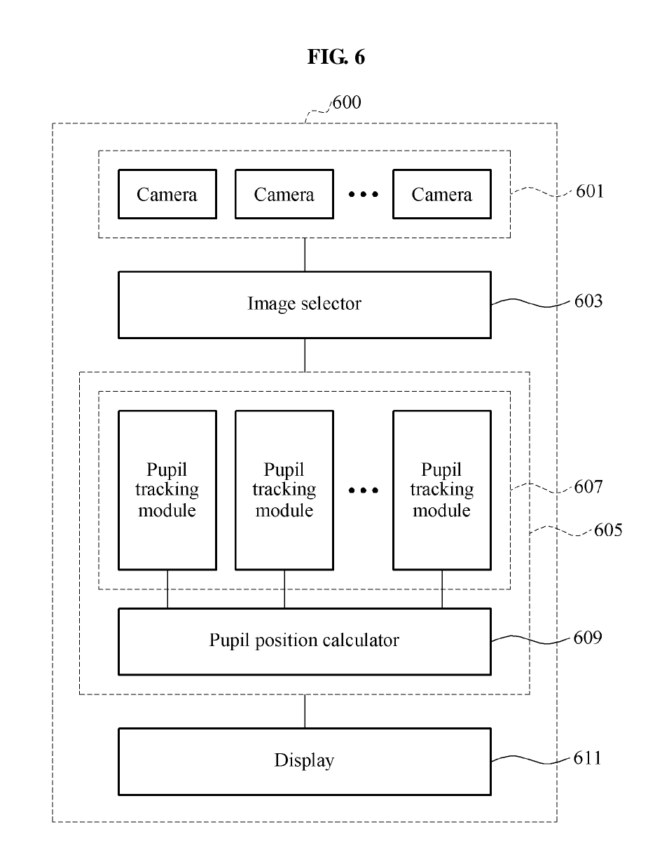

FIGS. 5A and 5B illustrate an example of tracking a position of a pupil using a pupil tracking apparatus according to an example embodiment of the present invention.

Referring to FIGS. 5A and 5B, the pupil tracking apparatus may track a pupil by calculating a position of the pupil based on, for example, a Haar feature-based approaching method.

In the Haar feature-based approaching method, a Haar feature may be configured to be a single filter set, a response for each filter may be configured to be a single classifier based on a face database, a output value obtained by passing an input image through the configured classifier may be compared to a threshold, and whether a face is included may be determined based on a result of the comparing.

In response to an input of an image, the pupil tracking apparatus may detect a candidate area of the eye or the face based on various size units. From the input image, the pupil tracking apparatus may detect a size unit having a greatest value output through a pupil classifier among the various unit sizes, for example, a greatest value output through a Haar classifier, as an area of the eye or the face. The pupil classifier may be used to numerically or probabilistically evaluate an area estimated as the pupil. The pupil classifier may be applied to the pupil tracking apparatus to evaluate an output value for each of a plurality of predetermined areas divided based on the image. The pupil tracking apparatus may compare output values evaluated by the pupil classifier with respect to the plurality of areas, and track an area evaluated to have the greatest output value as an eye area of the face.

When a position of the eye is detected, the pupil tracking apparatus may detect a position of the pupil based on a center of the eye as a reference. In this example, the pupil tracking apparatus may detect the position of the pupil based on that the pupil has a circular shape and the pupil is represented as a portion having a relatively low brightness in an image acquired by a camera.

In this example, the pupil tracking apparatus may detect the position of the pupil using a circle detection algorithm based on Equation 1.

$${max}_{( r , {x}_{0} , {y}_{0} )} \vert {G}_{σ} ( r ) * \frac{\partial }{\partial r} {∮}_{r , {x}_{0} , {y}_{0}} \frac{I ( x , y )}{2 π r} d s \vert \qquad [ Equation 1 ]$$

In Equation 1, I(x,y) denotes a pixel value of an (x,y) position, (x₀,y₀) denotes a center of a circle, and r denotes a radius.

For example, by using Equation 1, the pupil tracking apparatus may add all pixel values along circumferences normalized as 2πr by the radius r from the center (x₀,y₀). When a difference between an inner circumference and an outer circumference is maximized, the pupil tracking apparatus may determine a corresponding circumference as a pupil area. In this example, to remove noise, the pupil tracking apparatus may perform a Gaussian function G_{σ}(r) in a direction of the radius r in a process of detecting the circumference, thereby increasing accuracy in a pupil detection.

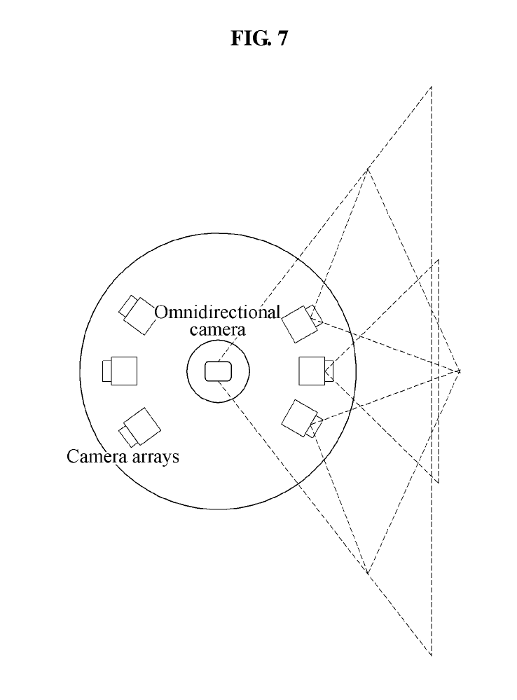

FIG. 6 illustrates a configuration of a pupil tracking apparatus 600 according to another example embodiment of the present invention.

Referring to FIG. 6, the pupil tracking apparatus 600 includes an image acquirer 601, an image selector 603, a space position detector 605, and a display 611.

The image acquirer 601 may include a plurality of cameras. In this example, the plurality of cameras may include one omnidirectional camera to capture an object in all directions, for example, in a range of 360°, and a plurality of panorama cameras to capture the object at different bearings to acquire an omnidirectional panoramic image.

In this example, the omnidirectional camera may extract an object, for example, a person, from an image. In response to an extraction of the object, the omnidirectional camera may transfer camera identification information or camera position information associated with the object, to the image selector 603. In this example, a camera related to the object may be a camera corresponding to a bearing at which the object is positioned.

The image selector 603 may receive a portion of the plurality of images acquired by the image acquirer 601. In this example, the image selector 603 may include, for example, a camera switch, select at least one panorama camera from the plurality of panorama cameras based on the camera identification information received from the omnidirectional camera, and receive an image from the at least one panorama camera by switching on the at least one panorama camera.

In the present disclosure, although the image selector 603 is described as receiving the camera identification information from the omnidirectional camera, the disclosure is not limited thereto. The image selector 603 may also receive an image from the omnidirectional camera, and acquire the camera identification information from the received image.

The space position detector 605 may detect a 3D position of a predetermined portion, for example, the pupil, in the object from at least one image received from the image selector 603. In this example, the space position detector 605 may include a pupil tracker 607 and a pupil position calculator 609.

The pupil tracker 607 may include a plurality of pupil tracking modules. The pupil tracker 607 may receive the at least one image from the image selector 603, and determine whether the received image includes the pupil. In this example, a pupil tracking module may divide the image into a plurality of predetermined areas, track, as an eye area of a face, an area having a greatest value output through a pupil classifier, for example, a Haar feature-based classifier among the divided areas, and track the pupil in the eye area.

In response to a determination that the image includes the pupil, the pupil tracking module may track 2D position of the pupil, for example, a left pupil and a right pupil, and transfer the 2D position to the pupil position calculator 609.

The pupil position calculator 609 may receive the 2D position of the pupil from each of the pupil tracking modules included in the pupil tracker 607, and calculate the 3D position of the pupil based on status information, for example, information on a direction, an angle, and a position of a camera, associated with the plurality of cameras.

The display 611 may output a hologram to a space corresponding to the 3D position of the pupil.

The pupil tracking apparatus 600 may detect the pupil based on the image acquired from an effective camera selected by the omnidirectional camera, for example, a selected portion of the panorama cameras. Through this, the pupil tracking apparatus 600 may reduce a number of calculations for detecting the pupil, thereby effectively tracking the position of the pupil.

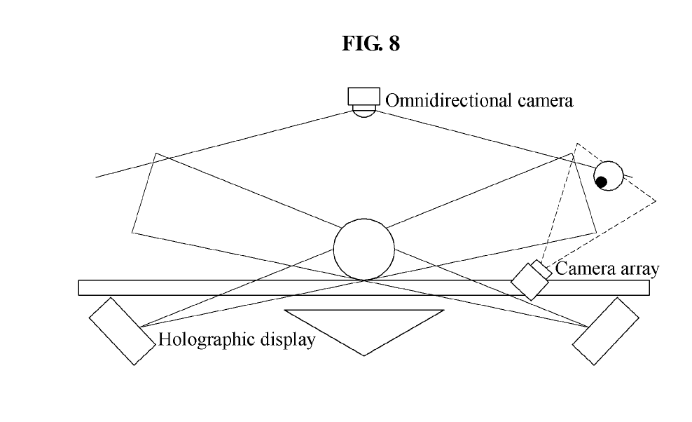

FIGS. 7 and 8 illustrate a camera arrangement in a pupil tracking apparatus according to another example embodiment of the present invention. FIG. 7 illustrates a camera arrangement viewed in a front direction, and FIG. 8 illustrates a camera arrangement viewed in a downward direction.

Referring to FIGS. 7 and 8, the pupil tracking apparatus may acquire a plurality of images by capturing an object, for example, a person, using a plurality of panorama cameras, for example, camera arrays, disposed at 360° bearings to acquire a 360° panoramic image, and one omnidirectional camera to capture the object in directions of 360° at once. When the camera arrangement is viewed in a front direction, the plurality of panorama cameras may be disposed at, for example, a lower portion based on the omnidirectional camera. When the camera arrangement is viewed in a downward direction, the plurality of panorama cameras may be disposed to be spaced apart from one another along a virtual circle based on the omnidirectional camera as a center.

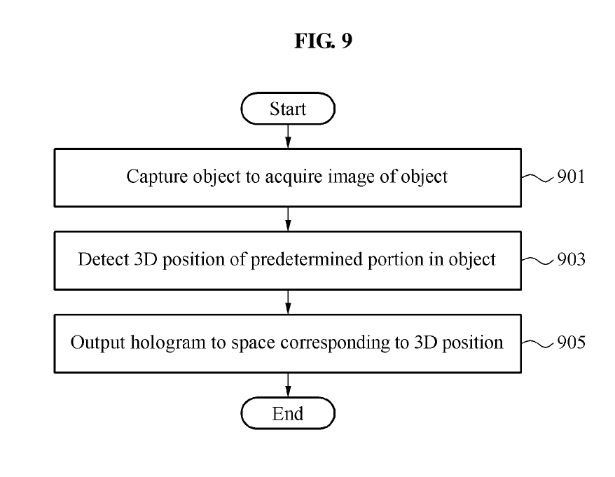

FIG. 9 illustrates a pupil tracking method according to an example embodiment of the present invention.

Referring to FIG. 9, in operation 901, the pupil tracking apparatus captures the object to acquire an image of the object.

In this example, the pupil tracking apparatus may acquire the image of the object using n cameras disposed at different bearings, n being a natural number. The n camera may correspond to one of a stereo camera, a color camera, and a depth camera.

In operation 903, the pupil tracking apparatus detects a 3D position of a predetermined portion in the object from the image.

The pupil tracking apparatus may determine whether the image includes a pupil as the predetermined portion. In response to a determination that the image includes the pupil, the pupil tracking apparatus may track a 2D position of the pupil. In this example, the pupil tracking apparatus may divide the image into a plurality of predetermined areas, track, as an eye area of a face, an area having a greatest value output through a pupil classifier, for example, a Haar feature-based classifier among the divided areas, and track the pupil in the eye area, thereby determining whether the image includes the pupil.

Subsequently, the pupil tracking apparatus may calculate the 3D position of the pupil based on the 2D position of the pupil and status information, for example, information on a direction, an angle, and a position of a camera, associated with a camera used to acquire the image.

In operation 905, the pupil tracking apparatus outputs a hologram to a space corresponding to the 3D position.

As another example, the pupil tracking apparatus may acquire an image of an object using an omnidirectional camera to capture the object in all directions, and a plurality of panorama cameras to capture the object at different bearings to acquire a panoramic image in all directions.

The pupil tracking apparatus may select at least one panorama camera from among the plurality of panorama cameras based on the camera identification information received from the omnidirectional camera. In response to an extraction of the object from the image, the pupil tracking apparatus may receive, from the omnidirectional camera, identification information associated with a camera corresponding to a bearing at which the object is positioned.

Subsequently, the pupil tracking apparatus may detect the 3D position of the predetermined portion in the object from the image acquired from the at least one panorama camera, and output the hologram to a space corresponding to the 3D position.

According to an aspect of the present invention, it is possible to accurately track a position of a pupil corresponding to a space to which a hologram is output, using an image acquired with respect to an object at a different angle, thereby extending a field of vision for a digital hologram display of which the field of vision is restricted in general.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) to and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially to configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A pupil tracking apparatus comprising:
an image acquirer to acquire an image of an object by capturing the object;
a space position detector to detect, from the image, a three-dimensional (3D) position of a predetermined portion in the object; and
a display to output a hologram to a space corresponding to the 3D position.

2. The apparatus of claim 1, wherein the image acquirer comprises n cameras disposed at different bearings, n being a natural number.

3. The apparatus of claim 2, wherein each of the n cameras corresponds to one of a stereo camera, a color camera, and a depth camera.

4. The apparatus of claim 1, wherein the space position detector comprises a pupil tracker to determine whether the image comprises a pupil as the predetermined portion, and track a two-dimensional (2D) position of the pupil in response to a determination that the image comprises the pupil.

5. The apparatus of claim 4, wherein the pupil tracker divides the image into a plurality of predetermined areas, tracks, as an eye area of a face, an area having a greatest value output through a pupil classifier among the divided areas, and tracks the pupil in the eye area.

6. The apparatus of claim 4, wherein the space position detector further comprises a pupil position calculator to calculate a 3D position of the pupil based on the 2D position of the pupil and status information associated with a camera in the image acquirer.

7. The apparatus of claim 1, wherein the image acquirer comprises:
an omnidirectional camera to omnidirectionally capture the object; and
a plurality of panorama cameras to capture the object at different bearings so as to acquire an omnidirectional panoramic image.

8. The apparatus of claim 7, further comprising:
an image selector to select at least one panorama camera from among the plurality of panorama cameras based on camera identification information received from the omnidirectional camera, receive an image from the selected panorama camera, and transfer the receive image to the space position detector.

9. The apparatus of claim 8, wherein when the object is extracted from the image, the omnidirectional camera provides, to the image selector, the camera identification information corresponding to a bearing at which the object is positioned.

10. A pupil tracking method comprising:
acquiring an image of an object by capturing the object;
detecting, from the image, a three-dimensional (3D) position of a predetermined portion in the object; and
outputting a hologram to a space corresponding to the 3D position.

11. The method of claim 10, wherein the acquiring comprises acquiring the image of the object using n cameras disposed at different bearings, n being a natural number.

12. The method of claim 11, wherein each of the n cameras corresponds to one of a stereo camera, a color camera, and a depth camera.

13. The method of claim 10, wherein the detecting comprises:
determining whether the image comprises a pupil as the predetermined portion; and
tracking a two-dimensional (2D) position of the pupil in response to a determination that the image comprises the pupil.

14. The method of claim 13, wherein the determining comprises dividing the image into a plurality of predetermined areas, tracking, as an eye area in a face, an area having a greatest value output through a pupil classifier among the divided areas, and tracking the pupil in the eye area.

15. The method of claim 13, wherein the detecting comprises calculating a 3D position of the pupil based on the 2D position of the pupil and status information associated with a camera used to acquire the image.

16. The method of claim 10, wherein the acquiring comprises acquiring the image of the object using an omnidirectional camera to omnidirectionally capture the object, and a plurality of panorama cameras to capture the object at different bearings so as to acquire an omnidirectional panoramic image.

17. The method of claim 16, wherein the pupil tracking method further comprises selecting at least one panorama camera from among the plurality of panorama cameras based on camera identification information received from the omnidirectional camera, and
wherein the detecting comprises detecting the 3D position of the predetermined portion in the object, from the image acquired using the selected panorama camera.

18. The method of claim 17, further comprising:
receiving, from the omnidirectional camera, the camera identification information corresponding to a bearing at which the object is positioned, in response to the extracting of the object from the image.
